(19) United States
(12) Patent Application Publication
(10) Pub. No.: US 2017/0169834 A1
(43) Pub. Date: Jun. 15, 2017

(54) ANDROID-BASED AUDIO CONTENT PROCESSING METHOD AND DEVICE

(71) Applicants: LE HOLDINGS (BEIJING) CO., LTD, Beijing (CN); LE SHI ZHI XIN ELECTRONIC TECHNOLOGY (TIANJIN) LIMITED, Tianjin (CN)

(72) Inventor: Mingxuan JIANG, Beijing (CN)

(73) Assignees: LE HOLDINGS (BEIJING) CO., LTD, Beijing (CN); LE SHI ZHI XIN ELECTRONIC TECHNOLOGY (TIANJIN) LIMITED, Tianjin (CN)

(21) Appl. No.: 15/240,465

(22) Filed: Aug. 18, 2016

Related U.S. Application Data
(63) Continuation of application No. PCT/CN2016/089519, filed on Jul. 10, 2016.

(30) Foreign Application Priority Data
Dec. 15, 2015 (CN) 2015109460518

(51) Int. Cl. G10L 19/22; G10L 19/10; G10L 19/008

(52) U.S. Cl. CPC G10L 19/22; G10L 19/008; G10L 19/10

(57) ABSTRACT

In the field of audio digital processing, an Android-based audio content processing method and device are provided. In an embodiment, the method includes: receiving, by a framework layer, audio content; identifying, by the framework layer, a type of the audio content, and adding an identifier associated with the type to the identified audio content; and receiving, by a hardware abstraction layer (HAL), audio content data and the identifier from the framework layer, and sending the audio content data to a processing unit corresponding to the identifier. In the embodiment, an Android framework layer is used to identify a type of audio content, and mark the type, and an HAL then sends, according to a mark, pulse coding modulation (PCM) data corresponding to the audio content to a processing unit corresponding to the type of the audio content, thereby implementing correct processing on audio content of different types. By means of the foregoing technical solution, coexistence of Dolby, a digital theater system (DTS), and high-fidelity (HiFi) in a same system is implemented.

### CROSS-REFERENCE TO RELATED APPLICATIONS

This application is a continuation of International Application No. PCT/CN2016/089519, with an international filing date of Jul. 10, 2016, which is based upon and claims priority to Chinese Patent Application No. 201510946051.8, filed on Dec. 15, 2015, the entire contents of all of which are incorporated herein by reference.

### TECHNICAL FIELD

The present disclosure relates to the field of audio digital processing, and in particular, to an Android-based audio content processing method and an electronic device.

### BACKGROUND

Dolby Surround is a sound that is encoded from a rear effect sound channel into a stereo channel. When Dolby Surround is replayed, a decoder is needed to separate a surround sound signal from an encoded sound. Because Dolby is an authority in the aspect of matrix surround sound processing, a Dolby Pro Logic technology has become a basis for a multichannel home television theater, and is also a reference decoding technology that makes surround audio tracks for tens of thousands of commercial video tapes, laser visions, DVDs, and television programs.

In a process of implementing the present disclosure, the inventor finds that, since a multichannel film sound format of Dolby Digital is released, the Dolby Digital has replaced the Dolby Surround, and has become a recommended decoding technology that provides multichannel audio for consumers by means of DVD-video compact discs, digital televisions, and games. However, each Dolby digital decoder is compatible with a Dolby Pro Logic stereo signal by means of an analog output port of the Dolby digital decoder.

Dolby Pro Logic is a special 4-2-4 coding technology invented by American Dolby Laboratories. The technology classifies sound field information into four pieces of information: left, middle, right, and surround information; then synthesizes the information into a dual channel by means of a specific coding technology; and during demo play, restores, by using a decoder, the dual channel into the four pieces of information for replaying. Because a carrier of the Dolby Pro Logic is a dual channel (stereo), the Dolby Pro Logic is well compatible with a conventional stereo device (for example, a mobile terminal like a mobile phone), and can be replicated by a common stereo device; a replicated program source can still obtain a surround sound effect the same as that of a master after being processed by a Dolby Pro Logic decoder.

Technically, a digital theater system (DTS) is completely different from other sound processing systems including the Dolby Digital. The Dolby Digital stores sound effect data between perforations of filmstrips. Because of limited space, a large quantity of compressed modes need to be used, resulting in that some sound quality has to be sacrificed. A DTS company resolves the problem by using a simple method, namely, storing sound effect data on another CD-ROM, and synchronizing the sound effect data with image data. In this way, the space is enlarged, and data traffic can also relatively become large; and further, the CD storing the sound effect data can be changed to play different language versions.

A definition of high-fidelity (Hi-Fi) is: a replayed sound has a high similarity to an original sound.

Currently, the foregoing several sound systems are used in most media files used in mobile terminals, for example, a mobile phone. A source file of any sound system becomes pulse code modulation (PCM) data after reaching a hardware abstraction layer (HAL), resulting in that targeted processing cannot be performed on different source files.

The prior art still has no good solution for the foregoing technical problem.

### SUMMARY

An objective of some embodiments of the present disclosure is to provide an Android-based audio content processing method and device; the method and device can effectively distinguish a source of PCM data, so as to perform targeted processing on the PCM data to reproduce a sound.

To achieve the foregoing objective, some embodiments of the present disclosure provide an Android-based audio content processing method, where the method includes: receiving, by a framework layer, audio content; identifying, by the framework layer, a type of the audio content, and adding an identifier associated with the type to the identified audio content; and receiving, by an HAL, audio content data and the identifier from the framework layer, and sending the audio content data to a processing unit corresponding to the identifier.

In an embodiment, the audio content data is PCM data; the method further includes: performing, by the framework layer, PCM on the audio content to obtain the audio content data; and sending, by the framework layer, the audio content data to the HAL.

In an embodiment, the method further includes: obtaining the audio content from a music/video player APP; and sending the audio content to the framework layer by using a media player/audio track application programming interface (API).

In an embodiment, the type of the audio content includes at least one of the following: Dolby Surround, Dolby Digital, Dolby Pro Logic Surround, a DTS, or Hi-Fi.

In an embodiment, the processing unit includes at least one of the following: a Dolby processing unit, a DTS processing unit, or a Hi-Fi processing unit.

According to an embodiment of the present disclosure, there is provided with a non-transitory computer-readable storage medium storing executable instructions that, when executed by an electronic device, cause the electronic device to perform an above disclosed method.

According to an embodiment of the present disclosure, there is provided with an electronic device. The electronic device includes: at least one processor; and a memory communicably connected with the at least one processor for storing instructions executable by the at least one processor, wherein execution of the instructions by the at least one processor causes the at least one processor to perform an above disclosed method.

By means of the foregoing technical solutions, an Android framework layer is used to identify a type of audio content, and mark the type, and an HAL then sends, according to a mark, PCM data corresponding to the audio content to a processing unit corresponding to the type of the audio content, thereby implementing correct processing on audio content of different types. By means of the embodiments of the present disclosure, coexistence of Dolby, a DTS, and Hi-Fi in a same system is implemented.

Other characteristics and advantages of some embodiments of the present disclosure are described in detail in a subsequent part of specific implementation manners.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of an Android-based audio content processing method in accordance with some embodiments.

FIG. 2 is a schematic structural diagram of an Android-based audio content processing system in accordance with some embodiments.

FIG. 3 is a schematic structural diagram of an Android-based audio content processing system in accordance with some embodiments.

FIG. 4 a schematic hardware diagram of an electronic device for performing an Android-based audio content processing method in accordance with some embodiments.

### DETAILED DESCRIPTION

The following describes specific implementation manners of the present disclosure in detail with reference to the accompanying drawings. It should be understood that the specific implementation manners described herein are merely used for describing and explaining the present disclosure, and are not used to limit the present disclosure.

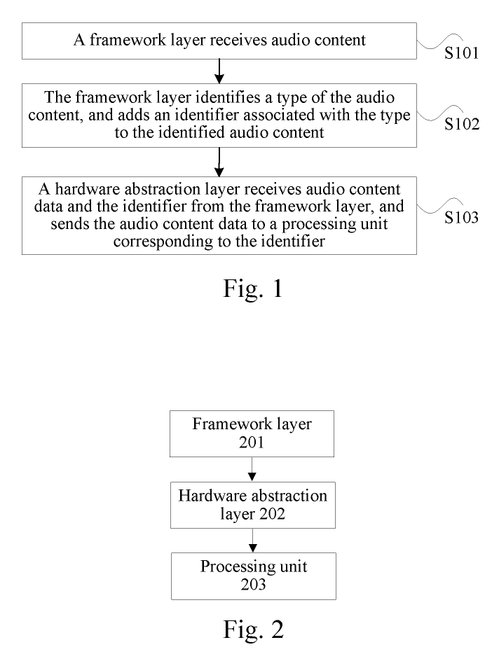

FIG. 1 is a flowchart of an Android-based audio content processing method according to an implementation manner of the present disclosure. As shown in FIG. 1, the Android-based audio content processing method provided by the implementation manner of the present disclosure may include: S101: A framework layer receives audio content; S102: The framework layer identifies a type of the audio content, and adds an identifier associated with the type to the identified audio content; and S103: An HAL receives audio content data and the identifier from the framework layer, and sends the audio content data to a processing unit corresponding to the identifier. The processing unit includes an algorithm for processing the audio content data.

By means of the foregoing technical solution, an Android framework layer is used to identify a type of audio content, and mark the type, and an HAL then sends, according to a mark, PCM data corresponding to the audio content to a processing unit corresponding to the type of the audio content, thereby implementing correct processing on audio content of different types. By means of the foregoing technical solution, coexistence of Dolby, a DTS, and Hi-Fi in a same system is implemented.

In the implementation manner, an identifier of a type, for example, a source type, may be added to the audio content in the framework layer, to identify or mark the type of the audio content. The identifier of the source type may be, for example, binding to the audio content or data corresponding to the identifier, so that the identifier accompanies each process of audio content processing. In the implementation manner, the identifier of the source type and the audio content data may be sent to the HAL (for example, an audio HAL) from the framework layer.

An Android system generally performs PCM on the audio content at the framework layer, to generate, PCM data for the HAL to use, as the audio content data. In the implementation manner, the method further includes: performing, by the framework layer, PCM on the audio content to obtain the audio content data, and sending, by the framework layer, the audio content data to the HAL.

In the implementation manner, the audio content may come from an Android APP. In a preferable implementation manner, the method provided by this embodiment of the present disclosure may further include: obtaining the audio content from a music/video player APP; and sending the audio content to the framework layer by using a media player/audio track API.

In the implementation manner, the type of the audio content may include at least one of the following: Dolby Surround, Dolby Digital, Dolby Pro Logic Surround, a DTS, or Hi-Fi. The type of the audio content can be selected according to an actual requirement to satisfy a more specific requirement of use.

In the implementation manner, corresponding to the type of the audio content, the processing unit may include at least one of the following: a Dolby processing unit, a DTS Processing Unit, or a Hi-Fi processing unit. The processing unit herein may be a digital signal processing (DSP) unit, which can process the audio content data by using a corresponding algorithm according to the type corresponding to the audio content data received by the DSP unit. In a preferable implementation manner, there may be multiple processing units, and each processing unit is responsible for processing one kind of audio content. In such an implementation manner, the HAL may be responsible for sending the audio content data to a corresponding processing unit according to the type.

FIG. 2 is a schematic structural diagram of an Android-based audio content processing system according to an implementation manner of the present disclosure. As shown in FIG. 2, the Android-based audio content processing system further provided by the implementation manner of the present disclosure may include: a framework layer 201, configured to receive audio content, where the framework layer 201 is further configured to identify a type of the audio content, and add an identifier associated with the type to the identified audio content; and an HAL 202, configured to receive audio content data and the identifier from the framework layer 201, and send the audio content data to a processing unit 203 corresponding to the identifier.

In the implementation manner, the audio content data may be PCM data, and the framework layer 201 is further configured to perform PCM on the audio content to obtain the audio content data; and send the audio content data to the HAL 202.

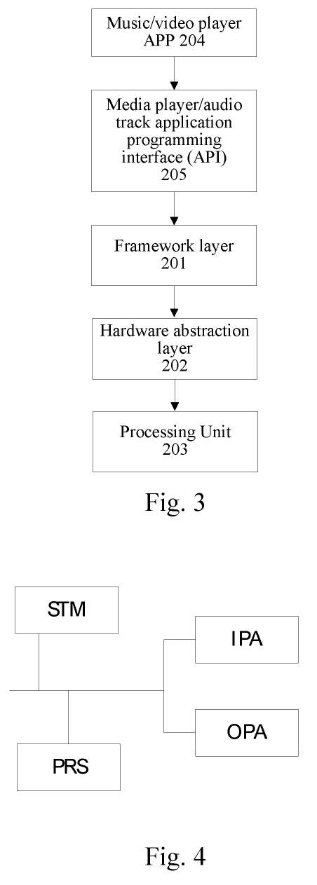

FIG. 3 is a schematic structural diagram of an Android-based audio content processing system according to a preferable implementation manner of the present disclosure. In the preferable implementation manner, the system may further include: a music/video player APP 204, configured to provide the audio content, where the framework layer 201 is further configured to receive the audio content by using a media player/audio track API 205.

In the foregoing implementation manner, the type of the audio content includes at least one of the following: Dolby Surround, Dolby Digital, Dolby Pro Logic Surround, a DTS, or Hi-Fi. The processing unit 203 may include at least one of the following: a Dolby processing unit, a DTS Processing Unit, or a Hi-Fi processing unit. It should be noted that there may be one or more processing units 203 in this embodiment of the present disclosure. In a case in which there are multiple processing units 203, each processing unit 203 may be responsible for processing one kind of audio content. The processing unit 203 taken for example may be a Dolby COPP that is responsible for processing Dolby content, a DTS COPP that is responsible for processing DTS content, and a Qualcomm QTI COPP that is responsible for processing Hi-Fi content. By means of the foregoing technical solution, coexistence of Dolby, a DTS, and Hi-Fi in a same system can be implemented.

According to an embodiment of the present disclosure, there is provided with a non-transitory computer-readable storage medium storing executable instructions that, when executed by an electronic device, cause the electronic device to perform any one of above disclosed methods.

FIG. 4 illustrates a schematic hardware diagram of an electronic device for performing any one of above disclosed methods. According to FIG. 4, the electronic device includes one or more processors PRS and a storage medium STM. FIG. 4 shows one processor PRS as an example.

The electronic device can further include an input device IPA and an output device OPA.

The one or more processors PRS, storage medium STM and output device OPA may be connected by a bus or other means. FIG. 4 shows a bus as an example for connection.

Storage medium STM is a non-transitory computer-readable medium for storing a non-transitory software program, a non-transitory computer-readable program and module, for example the program instructions/module for performing an above described method (e.g. Media player/audio track application programming interface 205, framework layer 201 and hardware abstraction layer 202 shown in FIG. 3). The processor PRS can operate the various functions and data processing of a server to perform a method described in the above embodiments by executing non-transitory software programs, instructions and modules stored in the storage medium STM.

The storage medium STM can include a program storage area and a data storage area. Among them, the program storage area may store operation system, application programs of at least one function; the data storage area may store generated data during operation of the electronic device for performing the method described in the above embodiments. In addition, the storage medium STM may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM may include a storage medium that is remote to the processor PRS. The remote storage medium may be connected to the electronic device for performing any of the above methods by a network. The examples of such as network include but not limited to Internet, enterprise intranet, local area network, mobile telecommunication network and a combination thereof.

The input device IPA can receive input number or byte information, and can generate input key information relating to user setting and functional control of the electronic device for performing the method described in the above embodiments. The output device OPA may include a display device such as a display screen.

The one or more modules stored in the storage medium STM that, when executed by the one or more processors PRS, can perform any of the above described methods.

The above products can perform any of the above described methods, and have corresponding functional modules and effects. Details that are not disclosed in this embodiment can be understood by reference to the above method embodiments of the present disclosure.

An electronic device of the present disclosure can exist in a varied form and includes but not limited to:
(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.
(2) A super-mobile personal computer which belongs to the field of a personal computer and has calculation and processing functions, and in general can access to a mobile network. Such a terminal device includes: a PDA, a MID and a UMPC etc., for example iPad.
(3) A portable entertainment device which is capable of displaying and playing multimedia content. Such a device includes: an audio player, a video player(e.g. iPod), a handheld game console, an electronic book, a smart toy and a portable automotive navigation device.
(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.
(5) Other electronic device that is capable of data exchange.

The above described device embodiments are for illustration purpose only, in which modules/units that are described above as separate elements may be physically separate or not separate and modules/units that are described above as display elements may be or may not be a physical unit, i.e. in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

The foregoing describes preferable implementation manners of the present disclosure in detail with reference to the accompanying drawings. However, the present disclosure is not limited to specific details in the foregoing implementation manners. Within a scope of technical ideas of the present disclosure, multiple simple variations can be made to the technical solutions of the present disclosure, and the simple variations all belong to the protection scope of the present disclosure.

In addition, it should be noted that each specific technical feature described in the foregoing specific implementation manners can be combined in any suitable manner when they are not contradictory. To avoid unnecessary repetition, the present disclosure makes no other explanations about each possible combination manner.

In addition, different implementation manners of the present disclosure can also be arbitrarily combined; as long as they do not violate the ideas of the present disclosure, they should also be considered as content disclosed by the present disclosure.

What is claimed is:

1. An Android-based audio content processing method performed by a user device, the method comprising:
receiving, by a framework layer of the user device, audio content;
identifying, by the framework layer of the user device, a type of the audio content;
adding an identifier associated with the type to the identified audio content; and
receiving, by a hardware abstraction layer (HAL) of the user device, audio content data and the identifier from the framework layer; and,
sending the audio content data to an audio processing unit corresponding to the identifier.

2. The method according to claim 1, wherein the audio content data is pulse code modulation (PCM) data, and the method further comprises:
performing, by the framework layer, PCM on the audio content to obtain the audio content data; and
sending, by the framework layer, the audio content data to the HAL.

3. The method according to claim 1, wherein the method further comprises:
obtaining the audio content from a music/video player APP; and
sending the audio content to the framework layer by using a media player/audio track application programming interface (API).

4. The method according to claim 1, wherein the type of the audio content comprises at least one of the following:
Dolby Surround, Dolby Digital, Dolby Pro Logic Surround, a digital theater system (DTS), and high-fidelity (Hi-Fi).

5. The method according to claim 1, wherein the audio processing unit comprises at least one of the following:
a Dolby processing unit, a DTS processing unit, and a Hi-Fi processing unit.

6. An electronic device, comprising:
at least one processor and a memory communicably connected with the at least one processor for storing instructions executable by the at least one processor;
wherein execution of the instructions by the at least one processor causes the at least one processor to:
identify a type of an audio content received by the electronic device;
add an identifier associated with the type to the identified audio content; and,
send audio content data to an audio processing unit corresponding to the associated identifier.

7. The electronic device according to claim 6, wherein the audio content data is pulse code modulation (PCM) data; and
wherein the memory further comprises instructions to:
perform PCM on the audio content to obtain the audio content data; and
send the audio content data to the audio processing unit.

8. The electronic device according to claim 6, wherein the memory further comprises instructions to obtain the audio content from a music/video player APP.

9. The electronic device according to claim 6, wherein the type of the audio content comprises at least one of the following:
Dolby Surround, Dolby Digital, Dolby Pro Logic Surround, a digital theater system (DTS), and high-fidelity (Hi-Fi).

10. The electronic device according to claim 6, wherein the audio processing unit comprises at least one of the following:
a Dolby processing unit, a DTS Processing Unit, and a Hi-Fi processing unit.

11. A non-transitory computer-readable storage medium storing executable instructions that, when executed by an electronic device, cause the electronic device to:
receive, by a framework layer of the electronic device, audio content;
identify, by the framework layer of the electronic device, a type of the audio content;
add an identifier associated with the type to the identified audio content; and
receive, by a hardware abstraction layer (HAL) of the user device, audio content data and the identifier from the framework layer; and,
send the audio content data to an audio processing unit corresponding to the identifier.

12. The storage medium according to claim 11, wherein the audio content data is pulse code modulation (PCM) data; and
wherein the memory further comprises instructions to:
perform PCM on the audio content to obtain the audio content data; and
send the audio content data to the audio processing unit.

13. The storage medium according to claim 11, wherein the storage medium further comprises instructions to obtain the audio content from a music/video player APP.

14. The storage medium according to claim 11, wherein the type of the audio content comprises at least one of the following:
Dolby Surround, Dolby Digital, Dolby Pro Logic Surround, a digital theater system (DTS), and high-fidelity (Hi-Fi).

15. The storage medium according to claim 11, wherein the audio processing unit comprises at least one of the following:
a Dolby processing unit, a DTS Processing Unit, and a Hi-Fi processing unit.
